(19) United States
(12) Patent Application Publication
(10) Pub. No.: US 2014/0132768 A1
(43) Pub. Date: May 15, 2014

(54) CAMERA FOR CAR

(71) Applicant: Samsung Electro-Mechanics Co., Ltd., Suwon (KR)

(72) Inventors: Young An CHOI, Hwasung (KR); Kwan Ha Jeong, Suwon (KR); In Taek Song, Suwon (KR)

(73) Assignee: Samsung Electro-Mechanics Co., Ltd., Suwon (KR)

(21) Appl. No.: 14/060,375

(22) Filed: Oct. 22, 2013

(30) Foreign Application Priority Data
Nov. 15, 2012 (KR) 10-2012-0129444

(51) Int. Cl. H04N 5/225; B60R 11/04

(52) U.S. Cl. CPC H04N 5/2252; B60R 11/04
USPC 348/148

(57) ABSTRACT

Disclosed herein is a camera for a car, and more particularly, a camera for a car with increased productivity by combining each component according to an ultrasonic fusion. There is provided a camera for a car including upper and lower housings having a lens assembly received therein and a harness coupled with the lower housing, the camera including: a rib provided at a corner of any one of the upper and lower housings, wherein a high frequency fusion is performed on an adhering portion of the upper and lower housings and between the lower housing and a harness.

### CROSS REFERENCE(S) TO RELATED APPLICATIONS

This application claims the benefit under 35 U.S.C. Section 119 of Korean Patent Application Serial No. 10-2012-0129444 entitled “Camera For Car” filed on Nov. 15, 2012, which is hereby incorporated by reference in its entirety into this application.

### BACKGROUND OF THE INVENTION

1. Technical Field

The present invention relates to a camera for a car, and more particularly, to a camera for a car with increased productivity by coupling each component according to an ultrasonic fusion.

2. Description of the Related Art

Generally, a camera for a car has been used as a rear camera that photographs a back of a car and informs a driver of the surrounding area of the rear of a car to prevent an accident risk, and the like or has been used for a black box that photographs the interior of a car and records situations at the time of accident.

The camera for a car includes a lens assembly, a printed circuit board, a holder, a housing, a harness connected with the housing, and the like and each component is generally fastened with each other by a screw or is bonded with each other by a bond.

However, when each of the components are fastened by a screw, a coupling space for screw coupling is required to increase a size of a camera for a car, such that there may be problems in that the amount of man hours required for assembly is increased and working efficiency is reduced.

In addition, when the bonding is performed so as to reduce a size of a camera, only a small amount of adhesive may be applied to each coupling portion, such that adhesion between respective components and the adhesion of each component are reduced.

To the contrary, when an adhesive is excessively applied to a coupling portion between respective components, the aesthetic appearance is affected or the adhesive is stuck to the printed circuit board, and the like, such that other components may be damaged.

Further, when the adhesive is excessively applied, the time to harden the adhesive is required, such that the processing time may be increased and the productivity may be reduced.

### RELATED ART DOCUMENT

### Patent Document

(Patent Document 1) Patent Document 1: Korean Patent Laid-Open Publication No. 2012-0016430

### SUMMARY OF THE INVENTION

An object of the present invention is to provide a camera for a car with improved assembling performance by a simple coupling of components using an ultrasonic fusion.

Another object of the present invention is to reduce a working process by performing a sealing process simultaneously with performing a tight waterproof process at the time of performing the ultrasonic fusion while maintaining a firm coupling relationship between respective components, thereby increasing productivity.

According to an exemplary embodiment of the present invention, there is provided a camera for a car including upper and lower housings having a lens assembly received therein and a harness coupled with the lower housing, the camera including: a rib provided at a corner of any one of the upper and lower housings, wherein a high frequency fusion is performed on an adhering portion of the upper and lower housings and between the lower housing and a harness.

An inside of the adhering portion of the upper and lower housings based on the rib may be subjected to the high frequency fusion.

An outside of the adhering portion of the upper and lower housings based on the rib may be further provided with a sealing rubber.

The upper and lower housings may be provided with groove portions so that the rib melted at the time of the high frequency welding is filled therein.

According to another exemplary embodiment of the present invention, there is provided a camera for a car including upper and lower housings having a lens assembly received therein and a harness coupled with the lower housing, the camera including: locking members each provided in the upper and lower housings, wherein a high frequency fusion may be performed on an adhering portion of the upper and lower housings and between the lower housing and a harness.

The locking members may be hooks each provided in the upper and lower housings.

The locking members may include fixed projections formed in the upper and lower housings and fixed holes fitted on the fixed projections.

### BRIEF DESCRIPTION OF THE DRAWINGS

FIG. 1 is a side cross-sectional view of a camera for a car according to an embodiment of the present invention.

FIG. 2 is a perspective view illustrating a state in which the camera for a car according to the embodiment of the present invention includes a rib.

FIG. 3 is a perspective view illustrating an inside of a housing among components of a camera for a camera according to the embodiment of the present invention.

FIG. 4 is a side cross-sectional view illustrating a state in which the housing of the camera for a car according to the embodiment of the present invention is coupled through a hook.

FIG. 5 is an exemplified diagram illustrating a state in which a high frequency fusion and a sealing are performed based on the rib among the components of the camera for a car according to the exemplary embodiment of the present invention.

### DESCRIPTION OF THE PREFERRED EMBODIMENTS

Hereinafter, exemplary embodiments of the present invention will be described in detail with reference to the accompanying drawings.

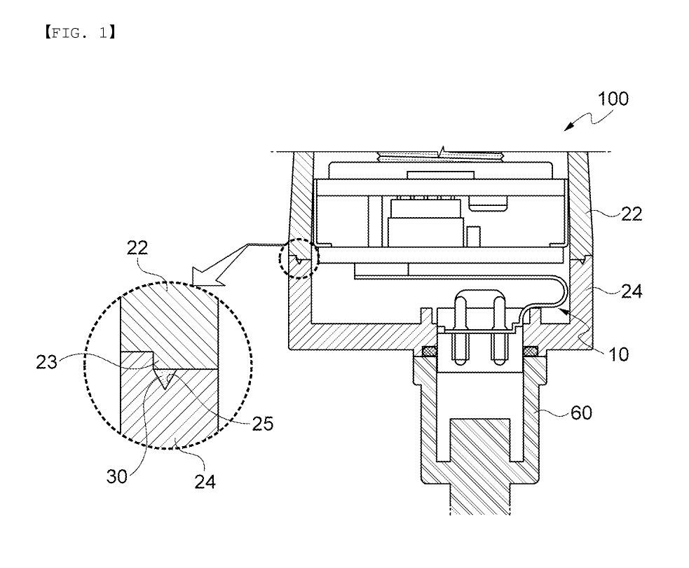

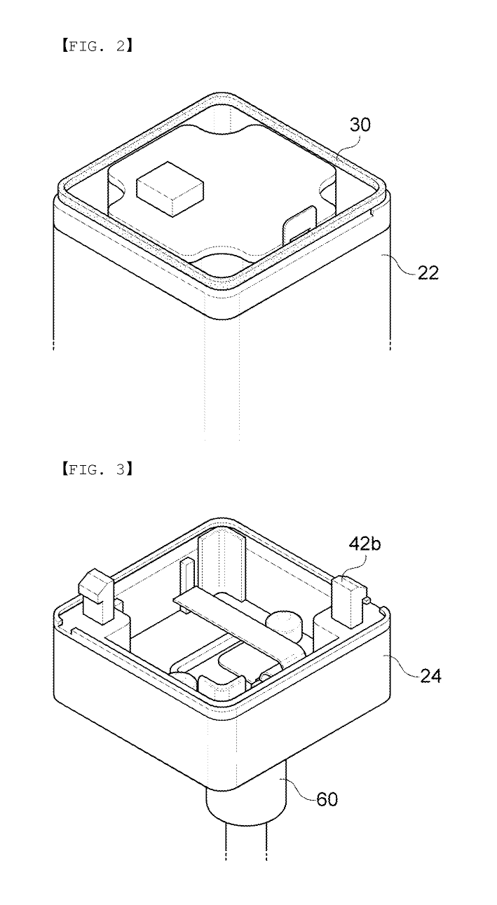

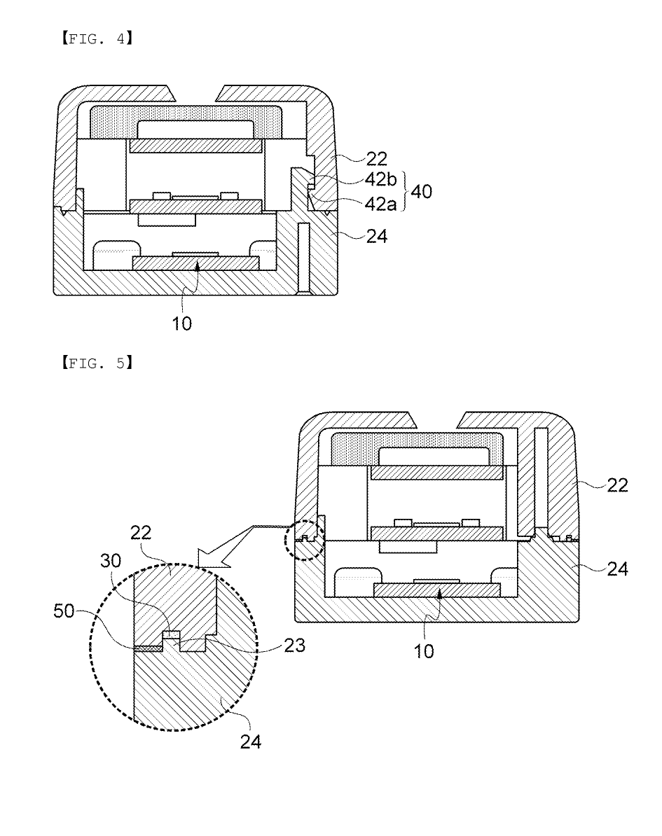

FIG. 1 is a side cross-sectional view of a camera for a car according to an embodiment of the present invention, FIG. 2 is a perspective view illustrating a state in which the camera for a car according to the embodiment of the present invention includes a rib, FIG. 3 is a perspective view illustrating an inside of a housing among components of a camera for a camera according to the embodiment of the present invention, FIG. 4 is a side cross-sectional view illustrating a state in which the housing of the camera for a car according to the embodiment of the present invention is coupled through a hook, and FIG. 5 is an exemplified diagram illustrating a state in which a high frequency fusion and a sealing are performed based on the rib among the components of the camera for a car according to the exemplary embodiment of the present invention.

As illustrated, a camera 100 for a car according to an embodiment of the present invention includes upper and lower housings 22 and 24 having a lens assembly received therein, locking members 40 each provided in the upper and lower housings 22 and 24, and a rib 30 provided at a corner of any one of the upper and lower housings 22 and 24. In this case, the high frequency fusion may be performed on an adhering portion of the upper and lower housings 22 and 24 coupled by the locking member 40 and between the lower housing 24 and a harness 60 to integrate the upper and lower housings 22 and 24 and the harness 60.

The lens assembly 10 may include a lens (no reference numeral) and a barrel (no reference numeral).

The lens assembly 10 is received in the upper and lower housings 22 and 24. The upper and lower housings 22 and 24 are injection molded using metal or synthetic resin and the inside thereof is designed according to the shape of the lens assembly 10 and the outside thereof may be variously performed in consideration with an aesthetic sense.

In addition, the insides of the upper and lower housings 22 and 24 are provided with the locking members 40. The locking member 40 is to configure the upper and lower housings 22 and 24 as one component and any one of the upper and lower housings 22 and 24 is provided with hooks 42 and the other thereof may be provided with a sill (not illustrated) for the hook to be locked thereto.

Further, the insides of the upper and lower housings 22 and 24 are each provided with the hooks 42 so as to be locked the housings 22 and 24 to each other, such that it is possible to prevent the housing 22 and 24 from easily separating from each other.

That is, the upper housing 22 has the sill or the hook 42 provided at an edge thereof and the lower housing 24 has a hook 42b provided at a predetermined portion of the inside thereof so that a hook 42a of the upper housing is fitted on the hook 42b, thereby locking the hooks 42a and 42b to each other as soon as the upper housing 22 is coupled with the lower housing 24.

Further, the locking member 40 may be configured to have a form in which the upper and lower housings 22 and 24 are each provided with fixed projections hole and fixed holes fitted on the fixed projections.

In other words, the fixed projection and the fixed hole are each provided at corners at which the upper and lower housings 22 and 24 face each other to naturally couple the upper and lower housings 22 and 24 with each other while the upper housing adheres to the lower housing 24.

Meanwhile, a rib 30 melted by the high frequency fusion may be formed at a corner of any one of the upper and lower housings 22 and 24. Preferably, a central portion of a corner of any one of the upper housing 22 and the lower housing 24 is provided with a protruded jaw 23 and the upper surfaces thereof may be provided with the rib 30.

Further, the housing in which the protruded sill 23 is not formed may be provided with a groove portion 25 so as to be fitted on the protruded sill 23.

For example, when the central portion of the upper housing 22 is provided with the protruded sill 23 along the corner thereof and the upper surface thereof is provided with the rib 30 along the protruded sill 23, the lower housing 24 may be provided the groove portion 25 so as to be coupled with the protruded sill 23 of the upper housing.

Therefore, when the upper housing 22 is coupled with the lower housing 24, the rib 30 may be disposed between the upper housing 22 and the lower housing 24.

In addition, the upper housing 22 and the lower housing 24 are subjected to the high frequency fusion so that the housings 22 and 24 are firmly adhered to each other.

The high frequency fusion is performed on the adhering portion of the upper housing 22 and the lower housing 24 to prevent foreign matters or moisture from being introduced through the adhering portion thereof.

In this case, the high frequency fusion may be partially performed on the insides of the upper and lower housings 22 and 24, based on the rib 30.

Further, the outsides of the housings 22 and 24 may be provided with a sealing rubbers 50 so as to prevent foreign matters and moisture from being introduced thereinto.

When the insides of the housings 22 and 24 based on the rib 30 are partially subjected to the high frequency fusion, the upper and lower housings 22 and 24 are more easily separated from each other, and then the lens assembly 10 may be repaired and replaced at the time of the damage of the lens assembly 10.

Further, the lower housing 24 is integrated with the harness by the high frequency fusion. The harness 60 is a connector that supplies power of a vehicle battery to the lens assembly 10.

According to the camera 100 for a car according to the exemplary embodiment of the present invention, the upper and lower housings 22 and 24 is fixed by the locking member 40 when the lens assembly 100 is disposed within the upper and lower housings 22 and 24.

In this case, the locking member 40 may be configured in various forms, but when the insides of the upper and lower housings 22 and 24 are configured in the hooks 42a and 42b, the locking between the hooks 42a and 42b is performed during the process of adhering the upper housing 22 to the lower housing 24. Here, only in any one of the upper and lower housings 22 and 24 is provided with the hook and the other thereof is provided with the sill.

When the lens assembly 10 is provided in the upper and lower housings 22 and 24, the upper and lower housings 22 and 24 are subjected to the high frequency fusion so as to maintain the firmly fixed state. The high frequency fusion may be performed over the adhering portion of the upper and lower housings 22 and 24 and may be partially performed according to the configuration of the rib 30.

When the rib 30 is provided at corners of the housings 22 and 24, the rib 30 is melted while the high frequency fusion is performed to fill the gap of the adhering portion of the upper and lower housings 22 and 24. Therefore, the upper and lower housings 22 and 24 may maintain the firm adhesion by the rib 30.

Further, the rib 30 may also be configured to partially perform the high frequency fusion in the state in which the rib is provided at the protruded sill 23 at the corner of the housing. In this case, based on the rib 30, the insides of the housings 22 and 24 are subjected to the high frequency fusion and the outsides thereof may be provided with the sealing rubber 50.

As such, when the lens assembly 10 is mounted in the upper and lower housings 22 and 24, the outer surface of the lower housing 24 is coupled with the harness 60 so as to be connected with the lens assembly 10. The harness 60 is integrated with the lower housing 24 by the high frequency fusion in the state in which the harness 60 is adhered to the outer surface of the lower housing 24.

Therefore, the coupling of the upper and lower housings 22 and 24 and the coupling of the lower housing 24 and the harness 60 are performed by the high frequency fusion, thereby providing the firmly fixed camera 100 for a car without adding the separate components.

According to the exemplary embodiments of the present invention, the camera for a car can increase the assemblage efficiency by simplified coupling between respective components using the ultrasonic fusion.

Further, according to the exemplary embodiment of the present invention, it is possible to reduce the working process by performing the sealing process simultaneously with the tight waterproof process at the time of performing the ultrasonic fusion while maintaining a firm coupling relationship between respective components, thereby increasing productivity.

Although the camera for a car according to the exemplary embodiments of the present invention is described above, the present invention is not limited thereto and therefore, applications and modifications thereof can be made by those skilled in the art.

What is claimed is:

1. A camera for a car including upper and lower housings having a lens assembly received therein and a harness coupled with the lower housing, the camera comprising:
a rib provided at a corner of any one of the upper and lower housings,
wherein a high frequency fusion is performed on an adhering portion of the upper and lower housings and between the lower housing and a harness.

2. The camera for a car according to claim 1, wherein an inside of the adhering portion of the upper and lower housings based on the rib is subjected to the high frequency fusion.

3. The camera for a car according to claim 1, wherein an outside of the adhering portion of the upper and lower housings based on the rib is further provided with a sealing rubber.

4. The camera for a car according to claim 1, wherein the upper and lower housings include a protruded sill protruded along a corner thereof and a groove portion fitted on the protruded sill and the protruded sill is provided with the rib.

5. The camera for a car according to claim 1, wherein the rib is provided on the protruded sill.

6. The camera for a car according to claim 4, wherein the rib is provided on the protruded sill.

7. A camera for a car including upper and lower housings having a lens assembly received therein and a harness coupled with the lower housing, the camera comprising:
locking members each provided in the upper and lower housings,
wherein a high frequency fusion is performed on an adhering portion of the upper and lower housings and between the lower housing and a harness.

8. The camera for a car according to claim 7, wherein the locking members are hooks each provided in the upper and lower housings.

9. The camera for a car according to claim 7, wherein the locking members include fixed projections formed in the upper and lower housings and fixed holes fitted on the fixed projections.
